(19) United States
(12) Patent Application Publication
(10) Pub. No.: US 2026/0227036 A1
(43) Pub. Date: Aug. 6, 2026

(54) METHOD FOR INTERNAL INTERVENTION IN STORAGE TANKS WITH FLOATING ROOFS

(71) Applicant: PETRÓLEO BRASILEIRO S.A. - PETROBRAS, RIO DE JANEIRO (BR)

(72) Inventors: Marcelo De Deus OLIVEIRA, Betim, Minas Gerais (BR); Jaime Dos Santos Souza FILHO, Betim, Minas Gerais (BR); Diego Dal MOLIN, Betim, Minas Gerais (BR); Marcos Antonio De OLIVEIRA, Betim, Minas Gerais (BR)

(73) Assignee: PETRÓLEO BRASILEIRO S.A. - PETROBRAS, RIO DE JANEIRO (BR)

(21) Appl. No.: 19/444,859

(22) Filed: Jan. 9, 2026

(30) Foreign Application Priority Data
Jan. 15, 2025 (BR) 1020250007827

(51) Int. Cl. F17C 13/12

(52) U.S. Cl. CPC F17C 13/12; F17C 2203/011; F17C 2221/032; F17C 2250/0447; F17C 2260/042

(57) ABSTRACT

The present invention relates to a method for internal intervention in storage tanks with floating roofs, comprising the steps of cleaning the tank repair area, physically determining the tank repair area, isolating the tank repair area by means of a ceramic blanket, adding sand to the isolated tank repair area, moistening the sand and monitoring the concentration of gases and vapors in the isolated repair area.

### RELATED APPLICATION DATA

This application is based on and claims priority to Brazilian Application No. BR 10 2025 000782 7, filed on Jan. 15, 2025, the entire contents of which are incorporated herein by reference.

### TECHNICAL FIELD

The present invention is situated within the scope of petroleum refining and derivatives and offshore oil production (E&P), specifically in the processes of oil production and storage. Thus, the present invention focuses on presenting a new methodology for internal interventions in oil tanks with floating roofs, whose residual volume contained inside after operational drainage is quite significant, requiring a considerable amount of time for its complete removal and decontamination. In this context, the new methodology allows for a significant reduction in the time required for localized intervention inside the equipment, without the need for complete removal of the hydrocarbon contained within.

### BACKGROUND OF THE INVENTION

Storage tanks are equipment and structures widely used in several industries, such as oil, gas, and chemicals, to store liquids or gases in a safe and controlled manner. This equipment plays a fundamental role in refineries and logistics terminals, offering large-scale storage capacity. However, their maintenance and operation have technical and safety challenges, especially in refineries and industrial environments due to the risk of explosion and leaks.

Although storage tanks are relatively simple in design compared to other equipment in the oil and gas industry, the costs and time involved in their maintenance are often high, especially in older installations. These tanks typically have a very long lifespan, around twenty-five years, and due to this time, there is a very large accumulation of residue that must be removed to allow for internal inspection of the equipment.

One of the biggest concerns associated with storage tanks is the possibility of explosions, since many of these tanks store flammable substances, such as hydrocarbons. The presence of combustible vapors combined with oxygen can create conditions conducive to the formation of an explosive atmosphere. In this scenario, one of the critical factors is controlling the atmosphere inside the tank, making it crucial to ensure that there are no nearby ignition sources and that oxygen levels are reduced to prevent combustion.

Maintaining tanks containing flammable products is a delicate matter, as cutting and welding processes, for example, generate heat and sparks that can cause explosions if the tank contains flammable vapors. Therefore, before any intervention, it is common to implement safety measures, such as tank inerting, which consists of replacing the oxygen inside with an inert gas, such as nitrogen, reducing the risk of explosions and making the tank environment inactive by reducing the oxygen content by replacing it with an inert gas.

Although storage tanks have a very long lifespan, unforeseen internal failures can occur that require corrective interventions to maintain the safe and reliable operation of the equipment. However, the intervention time for equipment containing this type of product (Petroleum) becomes very long, and can last around 6 to 9 months, depending on the tank diameter and the amount of accumulated residue. In this sense, a new methodology is needed that can allow for localized repairs quickly and with complete safety in a petroleum tank.

Furthermore, cleaning and decontaminating storage tanks are fundamental steps to extend the lifespan of the structures and ensure operational safety, as the accumulation of residues can obstruct the operation of the equipment, in addition to increasing the risk of structural failures and corrosion. Removing these residues involves specialized methods and appropriate equipment to handle hazardous chemicals.

Structural failures caused by corrosion, high pressure, or mechanical damage can lead to leaks in storage tanks. These leaks represent a significant operational risk and environmental hazard, as toxic and polluting substances can result in irreversible ecological damage, leading to soil and water contamination, as well as increasing repair costs.

In addition, in the case of large storage tanks, maintenance is a complex and time-consuming process, as it is necessary to empty the tank before any intervention. Added to this, the cleaning and decontamination process requires specialized equipment and trained workers, increasing the operational cost.

### STATE OF THE ART

The document U.S. Pat. No. 6,378,188 B1 discloses a method for preparing a fuel tank for repairs and verifying the repair work using an apparatus. The apparatus is connected to the fuel tank. The fuel tank is purged of oxygen to a certain level using a gas supplied by the apparatus until an oxygen level in the fuel tank reaches that level. The openings in the fuel tank are closed to the environment. The fuel tank is repaired while the oxygen level is maintained in the fuel tank. The gas supplied by the apparatus pressurizes the fuel tank to a certain pressure level. The pressure level is maintained for a specified period. In this way, the apparatus is connected to the fuel tank by means of connectors to connect the supply system and the relief system. Then, there is the introduction of inert gas into the tank to remove oxygen and make the environment non-reactive. Valves and connections are adjusted to regulate the flow and monitor the oxygen level, ensuring it stays below 6%. After the tank is inert, the repair is performed. During the process, the flow of inert gas is maintained to ensure safety and prevent reactions. After the repair, the tank is pressurized to 1.8 to 2.0 psig for testing. The valves are adjusted to regulate the pressure, and a visual and auditory inspection is performed. Soap solutions (“snoop”) are used to detect leaks. If problems are found, corrective adjustments can be made. The tank is vented, releasing gas through the opening of the valves. The tank plugs and caps are removed, and the apparatus is disconnected.

The method described in the document aims to prepare a fuel tank for repairs and verify the repair work using an apparatus. The apparatus is connected to the fuel tank. The fuel tank is purged of oxygen to a certain level using a gas supplied by the apparatus until an oxygen level in the fuel tank reaches that level. The openings in the fuel tank are closed to the environment. The fuel tank is repaired while the oxygen level is maintained in the fuel tank. The gas supplied by the device pressurizes the fuel tank to a certain pressure level. The pressure level is maintained for a specified period. On the other hand, unlike the present invention, the method in this document does not use scaffolding tubes, along with aluminum sheets and moistened sand, in addition to the installation of a ceramic blanket to isolate the area where the repair will be carried out.

The document CN 107138914 A discloses a method for repairing oil storage tanks without the need to interrupt production or empty the tank, comprising the following steps: identifying the location and size of defects in the storage tank; cleaning the affected area with sandblasting or descaling agents, removing rust, old coatings and dirt; filling the defects and corroded areas with a metallic repair agent, forming a continuous and resistant surface; applying a reinforced layer of epoxy fiberglass, 8 to 12 mm thick, to strengthen the repaired area; adding a carbon fiber reinforcement layer, 0.6 to 1 mm thick, for greater strength; and finishing with anti-corrosion coatings, which vary according to the environment (atmospheric, marine or underground), to extend the service life of the repair.

The method described in the document aims to repair oil storage tanks without the need to interrupt production or empty the tank, identifying the location to be repaired, cleaning the affected area and monitoring the environment, applying a reinforced layer of epoxy fiberglass, adding a layer of carbon fiber reinforcement and anti-corrosion coatings. On the other hand, unlike the present invention, the method in the document does not use scaffolding tubes, along with aluminum sheets and moistened sand, in addition to the installation of a ceramic blanket in order to isolate the location where the repair will be carried out.

The document KR 102591824 B1 discloses a method for opening and repairing liquefied gas storage tanks in operation, while said liquefied gas is inside the tank, using chemical anchoring reinforcements to correct the arching of the roof structure without demolishing the existing structure. The proposed method involves identifying areas of roof arching by measuring the space between the concrete roof and the steel roof plate using gap measurement units to determine the required reinforcement area. Drilling anchor holes through the steel roof plate and into the concrete roof in the determined areas. Installing chemical anchors in the anchor holes. Attaching a reinforcement pad and a lock nut around the chemical anchor. Performing sealant welding around the reinforcement pad, lock nut, and chemical anchor to ensure gas tightness. Installing displacement measuring devices in the reinforced areas to verify the behavior of the structure under operational pressure, to confirm structural stability. Finally, non-destructive tests are performed to check for possible defects or leaks.

The method described in the document aims to open and repair liquefied gas storage tanks during their operation, using chemical anchor reinforcements to correct the arching of the roof structure without demolishing the existing structure. The method involves identifying the location where the repair is to be carried out, installing chemical anchors, attaching a reinforcement pad and a locking nut around the chemical anchor, welding around the pad to ensure gas tightness, and monitoring the state of the gases in the environment. On the other hand, unlike the present invention, the method in this document does not use scaffolding tubes, along with aluminum sheets and moistened sand, in addition to installing a ceramic blanket to isolate the area where the repair will be carried out.

Thus, despite technological developments, the state of the art does not disclose a solution capable of performing localized interventions in oil storage tanks quickly, safely, and efficiently, especially in situations that demand the creation of ideal conditions for cut-and-release work or localized repairs without the need for complete removal of the residual product. In this sense, existing methodologies face significant limitations in terms of time, cost, and safety, due to the storage of flammable products (hydrocarbons) in the tanks.

The invention described below stems from continuous research in this segment, whose focus is to develop a solution capable of performing internal interventions in storage tanks efficiently and safely, significantly reducing the time required to perform repairs and the risks associated with the formation of an explosive atmosphere.

### OBJECTIVES

The objective of the present invention is to offer a method for internal interventions in storage tanks, allowing localized repairs to be carried out safely and in less time, without the need for complete removal of the residual product contained inside (hydrocarbons). Furthermore, this invention seeks to minimize the risks of explosive atmospheres by altering the atmosphere inside the equipment, allowing for localized repairs involving cutting and welding activities, ensuring the structural integrity of the tanks, safety, and reduced intervention costs.

Another objective of the present invention is to reduce the exposure of the workers to hazardous conditions during internal interventions in storage tanks, especially in waste removal activities, considerably increasing the safety level of the activity. In addition, the invention aims to use advanced methods that allow repairs to be carried out in controlled environments, minimizing environmental impacts and ensuring the resumption of operations with less downtime.

Thus, the present invention describes a method for internal interventions in floating roof oil tanks, allowing repairs to be carried out safely, economically, and with a significant reduction in localized intervention time inside the equipment, without the need for complete removal of the hydrocarbon contained within. The proposed method involves creating a controlled atmosphere inside the tank, drastically reducing risks associated with explosive atmospheres, as well as reducing maintenance costs and minimizing worker exposure to hazardous conditions.

### SUMMARY OF THE INVENTION

The present invention relates to a method for internal intervention in storage tanks with floating roofs, comprising the steps of: cleaning the tank repair area; physically determining the tank repair area; isolating the tank repair area by means of a ceramic blanket; adding sand to the isolated tank repair area; moistening the sand; monitoring the concentration of gases and vapors in the isolated repair area.

### BRIEF DESCRIPTION OF THE FIGURES

The present invention will be better understood from the detailed description and figures described below that refer to it.

FIG. 1 is a representation of a top view of a storage tank with floating roof.

FIG. 2 is a representation of the aluminum tile.

FIG. 3 is a representation of the positioning of the aluminum tile in the isolated repair area.

FIG. 4 is a representation of the scaffolding tube.

FIG. 5 is a representation of the positioning of the scaffolding tube in the isolated repair area.

FIG. 6 is a representation of a top view of an isolated repair area.

FIG. 7 is a flowchart illustrating the steps of internal intervention in storage tanks with floating roofs, according to the method of the present invention.

### DETAILED DESCRIPTION OF THE INVENTION

The following description constitutes only a preferred embodiment within the scope of the present invention.

The present invention aims to perform internal intervention in floating roof storage tanks containing a very large volume of residue in a very short time, allowing a significant reduction in the time required for localized intervention inside the equipment, without the need for complete removal of the hydrocarbon contained inside, generating significant savings in resources, intervention time and finances, since it allows the intervention to be carried out with complete safety, even when the product is present inside.

This solution is based on a technical step which is the modification of the atmosphere inside the equipment. Cutting and welding work cannot be performed inside equipment containing hydrocarbons due to their flammable nature, which generates an explosive atmosphere unsuitable for carrying out activities considered to be hot.

Therefore, the objective and development was to alter the atmosphere inside the equipment in order to allow for localized repair involving cutting and welding activities.

It is important to emphasize that the method disclosed by the present invention reduces the exposure of employees to residue removal work, considerably increasing the safety level of the activity, due to the reduction in execution time in the cleaning activity.

Thus, the method disclosed by the present invention consists of hermetically isolating the area inside the storage tank where the localized repair will be carried out and then proceeding with its complete cleaning and decontamination, thus altering the atmospheric conditions from explosive to an inert and decontaminated atmosphere.

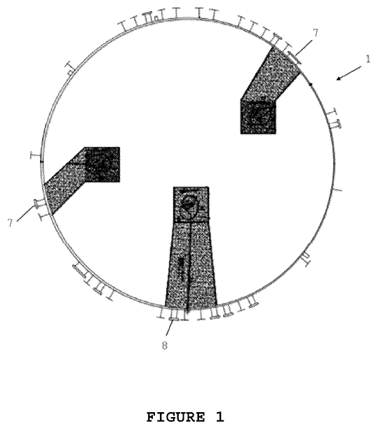

To this end, as can be seen in FIG. 1, access to the interior of storage tank 1 with a floating roof is achieved through the manhole 7 or the cleaning door 8.

Once the interior of storage tank 1 has been accessed, it is necessary to clean S100 the area where the repair will be carried out.

Next, the repair area of tank 1 will be physically determined S200, marking the location for the installation of aluminum sheets 3 reinforced with scaffolding tubes 2.

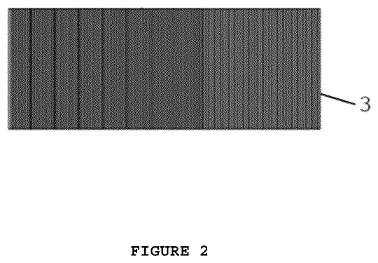

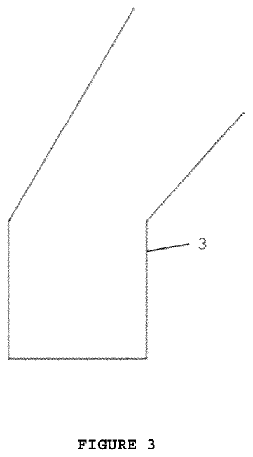

FIG. 2 shows the construction of the aluminum sheets 3 in detail, and FIG. 3 shows their respective positioning in the area where the repair will be carried out.

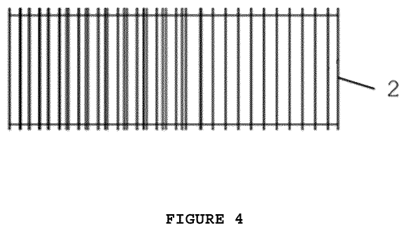

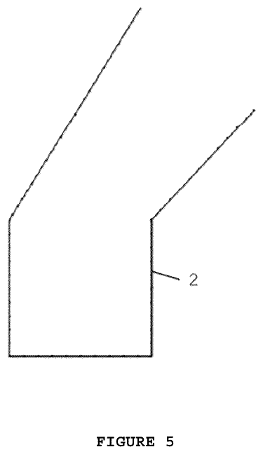

In FIG. 4, it is possible to observe the construction of the scaffolding tubes 2, which will support the aluminum sheets 3, and in FIG. 5, it is possible to observe the respective positioning of the scaffolding tubes 2 in the region where the repair will be carried out.

To achieve the objective of hermetically isolating the environment, ceramic blanket 6 was used to fill the empty spaces in the upper and lower regions of the insulation, so as not to allow the passage of gases from the uninsulated space to the insulated space.

Additionally, in order to eliminate the risk of welding and grinding sparks causing fire and/or explosion within the region where the repair will be carried out, sand 5 was added to the aforementioned region where the repair will be carried out.

However, the addition of sand 5 alone would not be sufficient to eliminate the occurrence of welding and grinding sparks causing fire and/or explosion within the area where the repair will be carried out. Therefore, sand 5 was moistened S500 by applying water in the form of a mist.

In this way, it is possible to obtain a highly moistened sand 5 on the floor under the area to be repaired. Therefore, any spark that might splash onto the floor of tank 1 would be instantly extinguished, thus promoting a very safe and appropriate environment for the type of repair to be carried out.

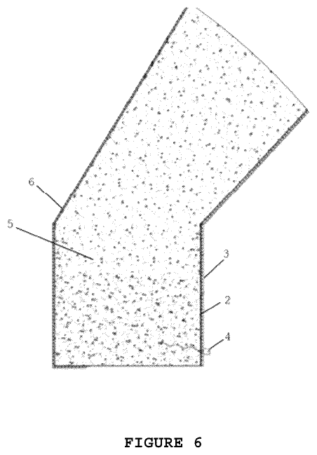

As illustrated in FIG. 6, it is possible to observe a top view of the isolated repair area, where the presence of scaffolding tubes 2, aluminum tiles 3, a gas and vapor detection device 4, moistened sand 5, and ceramic blanket can be seen.

The gas and vapor detection device 4 is intended to monitor the concentration of gases and vapors in the isolated repair area, since, at all times, said device 4 measures the percentage concentration of oxygen, explosive gases, CH₄, CO and H₂S.

Said gas and vapor detection device 4 is a portable gas detector that measures several different gases. Its main function is to provide safety through gas detection. The device indicates which gases are present in the environment and at what levels, so the professional knows which equipment to use and the risk they are facing.

After the described isolation is completed, adequate ventilation and lighting are used to allow the technical team to enter to perform the repair through the manhole 7 or the cleaning door 8.

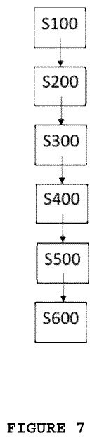

FIG. 7 represents a flowchart illustrating the sequence of steps performed by the present invention.

### EXAMPLE

In an example of the application of the present invention, the tank in question stores petroleum and has dimensions of 86.6 m in diameter and 14.6 m in height. The average level of residual sludge was 600 mm, making an average sludge volume of 3,534 m³ of residual product.

The repair in question was the replacement of the three drains on the roof of the petroleum storage tank. To achieve the replacement of the drains, it was necessary to cut the old drains, which are made of metal pipes, and weld specific nozzles and flanges to achieve a perfect installation of the new drains, which are made of flexible pipes.

Another technique used to allow the execution of the cutting and welding work within the isolated space was the measurement with specific equipment for detecting contaminating and flammable gases and vapors, prior to the release of the services and throughout the entire period of their execution. This action allowed for absolute control of atmospheric conditions at the site where the intervention took place, generating safe and reliable technical data.

All the planning work for this methodology was preceded by a thorough risk analysis involving a multidisciplinary team from the areas of maintenance, operation, and occupational safety.

This new methodology was successfully applied to an oil tank at Regap (Gabriel Passos Refinery), whose initial timeframe was eight months, considering seven months solely for internal cleaning. The use of the new methodology allowed for the complete cleaning and execution of the internal repair, saving approximately 3,000 m³ of product and seven months in the total intervention time.

The return of the storage tank to operation, in its turn, allowed for the release of another oil tank that is in the final phase of its operational campaign, thus generating safety in the operation of both pieces of equipment and reducing environmental risks by preventing and mitigating the risk of leaks of hydrocarbon-containing product, which is the basis of petroleum.

What is claimed is:

1. A method for internal intervention in a storage tank with a floating roof, comprising the steps of:
cleaning a repair area of the storage tank;
physically determining the repair area of the storage tank;
isolating the repair area of the storage tank by means of a ceramic blanket;
adding sand to the isolated repair area of the storage tank;
humidifying the sand; and
monitoring a concentration of gases and vapors in the isolated repair area.

2. The method according to claim 1, wherein the step of physically determining the repair area comprises marking a location for installation of aluminum sheets stiffened with scaffolding tubes.

3. The method according to claim 2, wherein the step of humidifying the sand comprises applying water in mist form to the sand.

4. The method according to claim 3, wherein the step of monitoring the concentration of gases and vapors comprises using a gas and vapor detection apparatus.

5. The method according to claim 4, wherein the gas and vapor detection apparatus measures a percentage concentration of oxygen, explosive gases, CH₄, CO and H₂S.

6. The method according to claim 2, wherein the step of monitoring the concentration of gases and vapors comprises using a gas and vapor detection apparatus.

7. The method according to claim 6, wherein the gas and vapor detection apparatus measures a percentage concentration of oxygen, explosive gases, CH₄, CO and H₂S.

8. The method according to claim 1, wherein the step of humidifying the sand comprises applying water in mist form to the sand.

9. The method according to claim 8, wherein the step of monitoring the concentration of gases and vapors comprises using a gas and vapor detection apparatus.

10. The method according to claim 9, wherein the gas and vapor detection apparatus measures a percentage concentration of oxygen, explosive gases, CH₄, CO and H₂S.

11. The method according to claim 1, wherein the step of monitoring the concentration of gases and vapors comprises using a gas and vapor detection apparatus.

12. The method according to claim 11, wherein the gas and vapor detection apparatus measures a percentage concentration of oxygen, explosive gases, CH₄, CO and H₂S.
